(19) United States
(12) Patent Application Publication
(10) Pub. No.: US 2026/0003092 A1
(43) Pub. Date: Jan. 1, 2026

(54) LOW-NOISE ULTRASONIC TRANSDUCER FOR USE IN WELLBORE OPERATIONS

(71) Applicant: Halliburton Energy Services, Inc., Houston, TX (US)

(72) Inventors: Jing Jin, Singapore (SG); Zeqing Sun, Singapore (SG); Chung Chang, Houston, TX (US)

(21) Appl. No.: 18/758,318

(22) Filed: Jun. 28, 2024

(51) Int. Cl. G01V 1/52; E21B 49/00; G01V 1/16; G01V 1/50

(52) U.S. Cl. CPC G01V 1/52; E21B 49/00; G01V 1/162; G01V 1/50

(57) ABSTRACT

An ultrasonic transducer for use in a downhole wellbore environment is disclosed. The ultrasonic transducer can utilize a piezoelectric element located in a housing comprising an inner housing and an outer housing separated by an air gap. The air gap functions to block undesirable ultrasonic waves from exiting or being received by the ultrasonic receiver and resulting in signal noise. For example, the air gap can prevent ultrasonic waves generated by the piezoelectric element from exiting the housing through a side or rear thereof, and can prevent reflected ultrasonic waves from being received by the ultrasonic transducer through a side or rear of the housing. The air gap may contain a gas or a fluid, or the air gap may be evacuated. The ultrasonic transducer may be a component of a downhole tool, such as a logging-while-drilling tool, or a post-drilling operation tool, such as a wireline tool.

### TECHNICAL FIELD

The present disclosure relates generally to wellbore operations, and more particularly (although not necessarily exclusively) to an ultrasonic transducer with improved noise characteristics that is deployable in a wellbore.

### BACKGROUND

In a hydrocarbon well environment, various drilling and post-drilling operations may employ downhole tools. For example, downhole tools may be used in logging-while-drilling (LWD) or post-drilling wireline logging operations. Logging operations, including open-hole wireline logging operations, can allow a well operator to obtain information about formation characteristics, hydrocarbon characteristics, and other characteristics about a well. Downhole tools can employ various technologies to obtain particular well information. In this regard, downhole tools may also employ different types of sensors, such as for example, ultrasonic transducers. Ultrasonic transducer-equipped downhole tools may be particularly useful, for example, in downhole wellbore imaging operations. At least when used for imaging, the signal-to-noise ratio of reflected ultrasonic wave signals received by an ultrasonic transducer has a direct bearing on the quality of the imaging that can be performed. Thus, it is desirable to eliminate or minimize noise in an ultrasonic transducer used in a wellbore.

### BRIEF DESCRIPTION OF THE DRAWINGS

FIG. 1 is a schematic diagram illustrating a well system that includes a downhole tool operating within a wellbore according to one example of the present disclosure.

FIG. 2 is a schematic diagram illustrating an air-gapped ultrasonic transducer according to an example of the present disclosure.

FIG. 3 is a schematic diagram illustrating an air-gapped ultrasonic transducer according to another example of the present disclosure.

FIG. 4 is a graph illustrating a lack of noise in a signal generated by an air-gapped ultrasonic transducer according to an example the present disclosure in response to detection of a reflected ultrasonic wave.

FIG. 5 is another graph illustrating a lack of noise in a signal generated by an air-gapped ultrasonic transducer according to an example of the present disclosure in response to detection of a reflected ultrasonic wave.

FIG. 6 is a flow chart representing one example of a method for eliminating or minimizing ultrasonic transducer noise according to an example of the present disclosure.

### DETAILED DESCRIPTION

Certain aspects and examples of the present disclosure relate to an ultrasonic transducer, and particularly to an ultrasonic transducer with improved noise characteristics that is usable in a downhole wellbore environment. Examples of an ultrasonic transducer according to the present disclosure can utilize a piezoelectric element located in a housing that includes an inner housing and an outer housing separated by an air gap. The air gap functions to block undesirable ultrasonic waves from exiting or entering the housing. For example, the air gap can prevent ultrasonic waves generated by the piezoelectric element from exiting the housing through a sidewall or rear wall thereof. Likewise, the air gap can prevent reflected ultrasonic waves from being received by a receiver (e.g., the piezoelectric element) of the ultrasonic transducer and resultantly producing noise. In some examples, the air gap may be filled with or otherwise contain a gas or a fluid. In other examples, the air gap may be in an evacuated state. Using the air gap to block the transmission or reception of undesirable ultrasonic waves can reduce or eliminate noise that may negatively impact use of the ultrasonic transducer in various well operations, such as for example, wellbore imaging operations.

In some examples, the ultrasonic transducer may be an ultrasonic transmitter only, meaning that the piezoelectric element only generates ultrasonic waves. In other examples, the ultrasonic transducer may be an ultrasonic receiver only, meaning that the piezoelectric element only detects reflected ultrasonic waves. In still other examples, the ultrasonic transducer may be an ultrasonic transceiver where the piezoelectric element both generates ultrasonic waves and detects (receives) reflected ultrasonic waves. In another example of an ultrasonic transceiver, the piezoelectric element can generate ultrasonic waves and another piezoelectric element or another type of sensor can detect reflected ultrasonic waves.

In some examples, the ultrasonic transducer may also include a backing material. The backing material may be located rearward of the piezoelectric element and may be made of a material that attenuates ultrasonic waves attempting to exit or enter the ultrasonic transducer through the rear of the housing. The backing material may also be selected such that an acoustic impedance of the backing material matches an acoustic impedance of a crystal material of the piezoelectric element.

The housing of the ultrasonic transducer can have an open front (a front opening) through which ultrasonic waves can be desirably transmitted and received. The opening may be closed by a cover. The cover may act as both a lens through which ultrasonic waves can pass, and a wear plate that protects the piezoelectric element and any other components within the housing from contact with a medium (e.g., well fluids) within which the ultrasonic transducer is located.

An ultrasonic transducer according to examples of the present disclosure may be used as or may be a part of a downhole tool. For example, an ultrasonic transducer may form or be part of a downhole tool sensor system. Examples of such downhole tools can include logging-while-drilling (LWD) tools, post-drilling tools such as tools that can be deployed downhole via a wireline, a slickline, or tubing. A downhole tool employing an ultrasonic transducer may be used to determine one or more characteristics related to a wellbore. For example, signals resulting from ultrasonic waves emitted by the ultrasonic transducer can be used to analyze formation features, hydrocarbon properties, casing features, wellbore fluids, or to determine the nature or location of objects in the wellbore. In one example, the downhole tool may be a cement evaluation tool. The cement evaluation tool can be deployable into the wellbore to, for example, evaluate a cement-to-pipe bond, a cement-to-formation bond, or a cement-to-casing bond, to determine the presence of cement between two casing strings, or to perform some combination of these operations

In some examples, the piezoelectric element of a downhole ultrasonic transducer can be activated to generate an ultrasonic wave within a fluid medium in the wellbore, and a resulting reflection of the ultrasonic wave within the wellbore can be subsequently detected by the ultrasonic transducer. Upon detection of a reflected ultrasonic wave, the receiver (e.g., piezoelectric element) of the ultrasonic transducer can generate a signal that is representative of the detected ultrasonic wave reflection. Signal data associated with the signal generated by the ultrasonic transducer can then be transmitted to and received by a computing device, which can analyze the signal data to determine one or more characteristics related to the wellbore.

Illustrative examples follow and are given to introduce the reader to the general subject matter discussed herein rather than to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

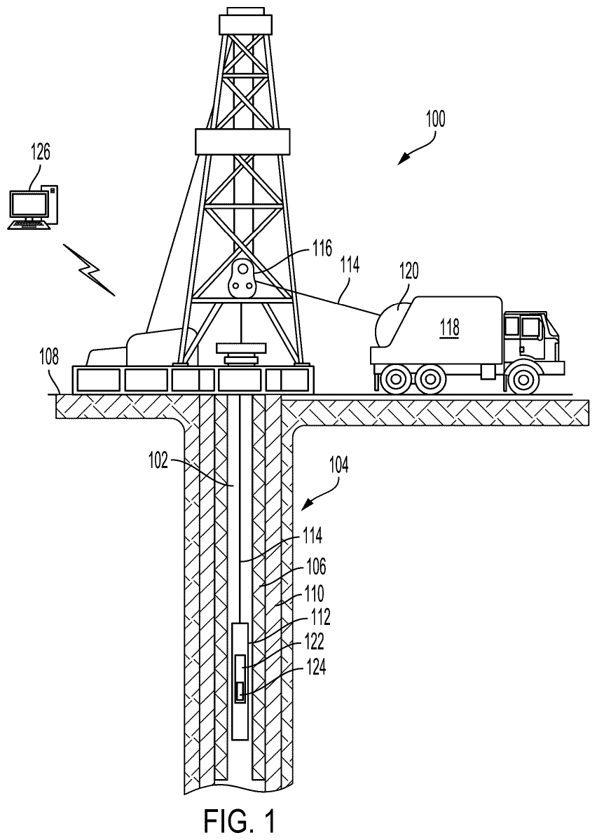

FIG. 1 illustrates one example of a well system 100. This particular example of the well system 100 includes a wellbore 102 that extends through a hydrocarbon-bearing subterranean formation 104. In other examples, the wellbore 102 may extend through a hydrocarbon-bearing subsea formation. As shown, the wellbore 102 includes a casing string 106 that extends from a well surface 108 through the subterranean formation 104. The casing string 106 can act as a conduit through which formation fluids, such as production fluids produced from the subterranean formation 104, can travel from the wellbore 102 to the surface 108. The casing string 106 can be cemented into the subterranean formation 104. For example, cement 110 may be pumped into an annulus formed between the casing string 106 and the wall of the wellbore 102 to couple the casing string 106 to the wellbore 102.

The well system 100 can also include at least one well tool 112 (e.g., a formation-testing tool). In one example, the well tool 112 may be a cement evaluation tool. The well tool 112 can be deployed downhole in the wellbore 102 by, for example, a wireline 114, a slickline, or by coiled tubing. The wireline 114, slickline, or coiled tubing can be lowered into the wellbore 102 using, for example, a guide 116 and a wireline conveyance mechanism such as a wireline truck 118. In some examples, the wireline 114, slickline, or coiled tubing can be wound around a reel 120 on the wireline conveyance mechanism (e.g., wireline truck 118).

In some examples, the well tool 112 can include an ultrasonic sensor system 122. The ultrasonic sensor system 122 can include an ultrasonic transducer 124. The ultrasonic transducer 124 can transmit ultrasonic waves into a fluid medium in the wellbore 102 within which the ultrasonic transducer 124 is positioned. The ultrasonic transducer 124 can generate ultrasonic waves that are directed outward from the well tool 112 to interact with features of the wellbore 102 or objects located within the wellbore 102. In an example, the ultrasonic transducer 124 can generate and transmit ultrasonic frequency (e.g., pressure) waves by vibration of a piezoelectric element of the ultrasonic transducer 124 in the fluid medium. The fluid medium can include a gas or a liquid, such as oil, water, or mud. The mud can be drilling mud. Ultrasonic waves emitted by the ultrasonic transducer 124 can propagate through the fluid medium and may be reflected by one or more features of or objects in the wellbore 102. In some examples, the ultrasonic waves can reflect off of the subterranean formation 104, the casing string 106, the cement 110, one or more objects in the wellbore 102, or any combination thereof.

In some examples, the ultrasonic sensor system 122 can detect the reflected ultrasonic waves using an ultrasonic receiver or multiple ultrasonic receivers that are separate from an ultrasonic transmitter of the ultrasonic sensor system 122. For example, the ultrasonic sensor system 122 can include an array of ultrasonic receivers that are operable to detect reflected ultrasonic waves. Examples of an ultrasonic receiver other than the ultrasonic transducer 124 can include a microphone, a hydrophone, or another sensor capable of detecting waves in the frequency range of the ultrasonic waves emitted by the ultrasonic transducer 124.

In some examples, a pair of the ultrasonic transducers 124 can operate in a pitch-catch mode, whereby one ultrasonic transducer 124 of the pair of the ultrasonic transducers pitches (transmits) ultrasonic waves and the other ultrasonic transducer 124 of the pair of the ultrasonic transducers 124 catches (receives) reflections of the transmitted ultrasonic waves. In some examples, a single ultrasonic transducer 124 or a pair of the ultrasonic transducers 124 may operate in a pulse-echo mode. In the case of pulse-echo mode operation, the transmitting ultrasonic transducer 124 emits short bursts of ultrasonic waves, which are received either by the transmitting ultrasonic transducer 124 itself, or a second ultrasonic transducer 124 of a pair of the ultrasonic transducers.

The ultrasonic sensor system 122 can analyze one or more characteristics of the reflected ultrasonic wave signals. For example, the ultrasonic sensor system 122 can include a computing system 126 to which signal data associated with signals generated by the ultrasonic transducer 124 or another ultrasonic receiver in response to detection of reflected ultrasonic waves within the wellbore, may be transmitted or otherwise provided for analysis. In one example, the ultrasonic sensor system 122 can be used to perform an imaging operation whereby features of the wellbore 102 or objects within the wellbore 102 can be determined based on the analyzed characteristics of the signals generated in response to detection of reflected ultrasonic waves. In some examples, the ultrasonic sensor system 122 can be used to perform location functions. For example, the ultrasonic sensor system 122 can use an ultrasonic wave time of flight (e.g., the time between ultrasonic wave transmission and subsequent detection by a receiver) and a known ultrasonic wave velocity in the given fluid medium, to determine a location of an object within the wellbore 102. In some examples, the ultrasonic sensor system 122 can be used to determine a type, a composition, or another characteristic of an object within the wellbore 102, an impedance of a wellbore material, or an existence of a deformity in a wall of the wellbore 102, such as but not limited to a fracture. The analyzed characteristics of the received signal data can also be used for caliper applications, whereby the diameter or shape of the wellbore 102 can be determined.

In the case of an ultrasonic transducer, the transmission of generated ultrasonic waves in an intended direction (i.e., from a front of the ultrasonic transducer) is desirable, while the propagation of generated ultrasonic waves in an unintended direction—i.e., through a rear or a side(s) or otherwise through a housing of the ultrasonic transducer—is undesirable. Likewise, the receipt of reflected ultrasonic waves from an intended direction (i.e., through a front of the ultrasonic transducer) is desirable, while receipt of reflected ultrasonic waves from an unintended direction—i.e., through a rear or a side(s) or otherwise through the housing of the ultrasonic transducer—is undesirable. When an ultrasonic wave is transmitted by and reflected back to an ultrasonic transducer on substantially the same (intended) path, the resulting signal produced by (the receiver of) the ultrasonic transducer is typically substantially free of noise and indicative of a characteristic or location of a surface, object, etc., from which the ultrasonic wave was reflected. In contrast, generated ultrasonic waves that are transmitted through the ultrasonic transducer housing in an undesirable direction are typically reflected back to and received by (the receiver of) the ultrasonic transducer through a side or a rear or otherwise through the housing and can add a considerable amount of undesirable noise to the ultrasonic transducer signal. Therefore, it is desirable with respect to an ultrasonic transducer to prevent or minimize the transmission of generated ultrasonic waves in unintended directions and also to prevent or minimize the receipt of reflected ultrasonic waves from unintended directions.

With respect to an imaging operation using an ultrasonic tool, for example, the imaging quality is highly dependent on the quality of the received ultrasonic wave signal. For example, acceptable wellbore ultrasonic imaging typically requires a signal-to-noise ratio (SNR) greater than 20 decibels or even as much as or greater than 30 decibels in some cases. When an ultrasonic transducer experiences noise due to the unwanted propagation of ultrasonic waves, the SNR of the ultrasonic transducer may be well below a desired (e.g., 20-30 decibel) level.

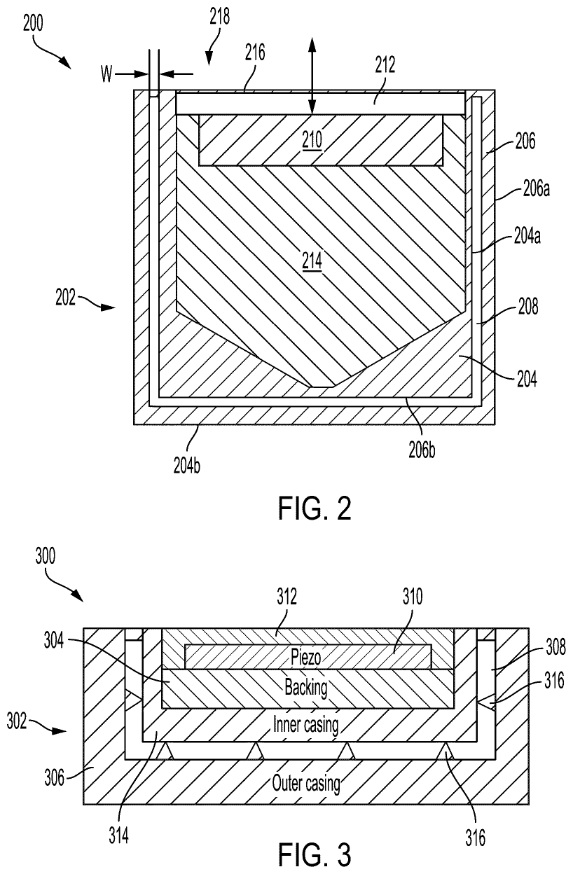

Examples of an ultrasonic transducer with an air-gapped housing (i.e., an “air-gapped ultrasonic transducer”) according to the present disclosure can minimize or eliminate noise problems such as those described above. FIG. 2 schematically depicts one example of such an air-gapped ultrasonic transducer 200. In various examples, the air-gapped ultrasonic transducer 200 can operate as an ultrasonic transmitter only, an ultrasonic receiver only, or as an ultrasonic transceiver having both transmitting and receiving functionality. When the air-gapped ultrasonic transducer 200 is a receiver or a transceiver, the air-gapped ultrasonic transducer 200 can detect reflections of transmitted ultrasonic waves from objects or materials in the environment of the air-gapped ultrasonic transducer 200. The environment may be a wellbore environment.

The air-gapped ultrasonic transducer 200 includes a housing 202 comprising an inner housing 204 that is separated from an outer housing 206 by an air gap 208. The inner housing 204 and the outer housing 206 each have at least one side wall 204a, 206a, a rear wall 204b, 206b. An opening 216 may be present at a front 218 of the air-gapped ultrasonic transducer 200. In this example, the housing 202 of the air-gapped ultrasonic transducer 200 is of round cross-sectional shape, and thus each of the inner housing 204 and the outer housing 206 has only a single continuous sidewall. Other air-gapped ultrasonic transducer examples may have other shapes, and thus may have more than one sidewall.

In some examples, the inner housing 204 and the outer housing 206 may be made of the same material or of dissimilar materials. For example, the inner housing 204 and the outer housing 206, or at least the outer housing 206, may be made from a material that is resistant or impervious to a medium in which the air-gapped ultrasonic transducer 200 will be placed. In some examples, one or both of the inner housing 204 and the outer housing 206 may be made of metal. In other examples, one or both of the inner housing 204 and the outer housing 206 may be made of a plastic material, a composite material, or one or more other materials that exhibit sufficient strength to withstand downhole wellbore pressures to which the air-gapped ultrasonic transducer 200 may be exposed without excessive deformation. Excessive deformation may be defined as a deformation of at least the outer housing 206 that diminishes the size of one or more portions of the air gap 208, or causes a collapse of one or more portions of the air gap 208, to an extent where the air gap 208 can no longer adequately perform its intended ultrasonic wave blocking function.

The air gap 208 can be seen to extend along the side walls 204a, 206a and the rear walls 204b, 206b of the inner housing 204 and the outer housing 206. The purpose of the air gap 208 is to block generated ultrasonic waves from being transmitted outward from the air-gapped ultrasonic transducer 200 through the side or the rear of the housing 202, and also to prevent reflected ultrasonic waves from entering and being received by a receiver of the air-gapped ultrasonic transducer 200 through the side or the rear of the housing 202. In this manner, it can be ensured that the transmission and receipt of ultrasonic waves by the air-gapped ultrasonic transducer 200 occurs exclusively or primarily through the front 218 thereof (as indicated by the arrow).

The width (W) of the air gap 208—i.e., the separation distance between the inner housing 204 and the outer housing 206—can vary depending on the size of air-gapped ultrasonic transducer 200, the transmitting power of the piezoelectric element 210, the material from which the inner housing 204 and outer housing 206 is made, the effectiveness of a backing material 214 that may be present within the inner housing 204 to help attenuate undesirable ultrasonic waves, etc. While referred to herein as an air gap for purposes of description, the air gap 208 may or may not include air. In some examples, the air gap 208 may be filled with air. In other examples, the air gap 208 may be filled with another gas, or with a liquid. In another example, the air gap 208 may be evacuated. In any case, the air gap 208, and any gas or fluid within the air gap 208, is functional to block ultrasonic waves from leaving or being received by the air-gapped ultrasonic transducer 200 through the side or rear thereof, while not blocking or otherwise negatively affecting ultrasonic wave transmission or reception from the front 218 of the air-gapped ultrasonic transducer 200.

The air-gapped ultrasonic transducer 200 can also be seen to include a piezoelectric element 210 that is located within the housing 202. The piezoelectric element 210 can be caused to vibrate at a desired frequency or within a desired frequency range when a voltage is applied thereto, such as in response to a command from a controller or another device. Vibration of the piezoelectric element 210 in a fluid medium (e.g., well fluids) can generate ultrasonic waves that may be transmitted from the air-gapped ultrasonic transducer 200 and can propagate through the fluid medium. In some examples, the piezoelectric element 210 can also operate as a receiver that can detect reflected ultrasonic waves. In other examples, the air-gapped ultrasonic transducer 200 can include one or more separate receiving elements (not shown) that may reside in a space within the inner housing 204 along with the piezoelectric element 210 to detect reflected ultrasonic waves.

A cover 212 may be located along a front of the housing 202 to close the opening 216 at the front 218 of the housing 202. The cover 212 is made of a material through which ultrasonic waves can be transmitted. The cover 212 is also preferably made of a material that is compatible with the material of the inner housing 204 or the outer housing 206 to which the cover 212 can be affixed or otherwise in contact. The cover 212 preferably seals the housing 202 such that the piezoelectric element 210 is not exposed to the medium (e.g., wellbore fluids) in which the air-gapped ultrasonic transducer 200 is located. In some examples, installation/sealing of the cover 212 to the housing 202 may utilize an epoxy material.

As mentioned above, the air-gapped ultrasonic transducer 200 can also include a backing material 214 that helps to attenuate the undesirable transmission of ultrasonic waves through a rear of the housing 202. The backing material 214 may be made of any material known to be usable for such a purpose. The backing material 214 may work in conjunction with the air gap 208 to help block ultrasonic waves from exiting or being received by the air-gapped ultrasonic transducer 200 through the rear of the housing 202.

In operation, the front 218 of the air-gapped ultrasonic transducer 200 is aimed to transmit ultrasonic waves in a desired direction—e.g., into downhole well fluids located in a wellbore—and to detect reflections of the transmitted ultrasonic waves from wellbore structures or features, or from objects located within the wellbore. When located in a wellbore, the air-gapped ultrasonic transducer 200 can be used to perform any of the operations described above, such as but not limited to, imaging of the wellbore.

FIG. 3 schematically depicts another example of an air-gapped ultrasonic transducer 300 according to the present disclosure. The air-gapped ultrasonic transducer 300 is similar to the air-gapped ultrasonic transducer 200, and includes a housing 302 comprising an inner housing 304 separated from an outer housing 306 by an air gap 308. The air-gapped ultrasonic transducer 300 further includes a piezoelectric element 310 that can generate ultrasonic waves in a medium within which the air-gapped ultrasonic transducer 300 resides and can also detect reflected ultrasonic waves. A cover 312 is again present to close and seal a front opening in the housing 302, and a backing material 314 to help attenuate the transmission of ultrasonic waves through a rear of the housing 302.

As shown, the air-gapped ultrasonic transducer 300 further includes a number of air gap support elements 316 that reside within the air gap 308, and wherein each air gap support element extends completely or substantially completely between an outer wall of the inner housing 304 and an inner wall of the outer housing 306. The air gap support elements 316 can help to prevent deformation or collapse of the air gap 308 if the air-gapped ultrasonic transducer 300 is subjected to significant external pressures, such as for example, when the air-gapped ultrasonic transducer 300 is deployed deep within a fluid of a wellbore. The air gap support elements 316 may also allow one or both of the outer housing 306 and the inner housing 304 to be manufactured of materials of lesser strength than what might otherwise be necessary to prevent deformation of the air gap 308 when the air gap support elements 316 are not present.

As illustrated in FIG. 3, the air gap support elements 316 may be located within the air gap 308 at spaced intervals. No particular spacing between air gap support elements 316 is required, but the quantity of air gap support elements 316 used is preferably limited to a number that will not inhibit the desired blocking of ultrasonic waves by the air gap 308. While a shape of the air gap support elements 316 is shown to be substantially triangular or conical in the example of FIG. 3, it should be understood that other air gap support element shapes are also possible.

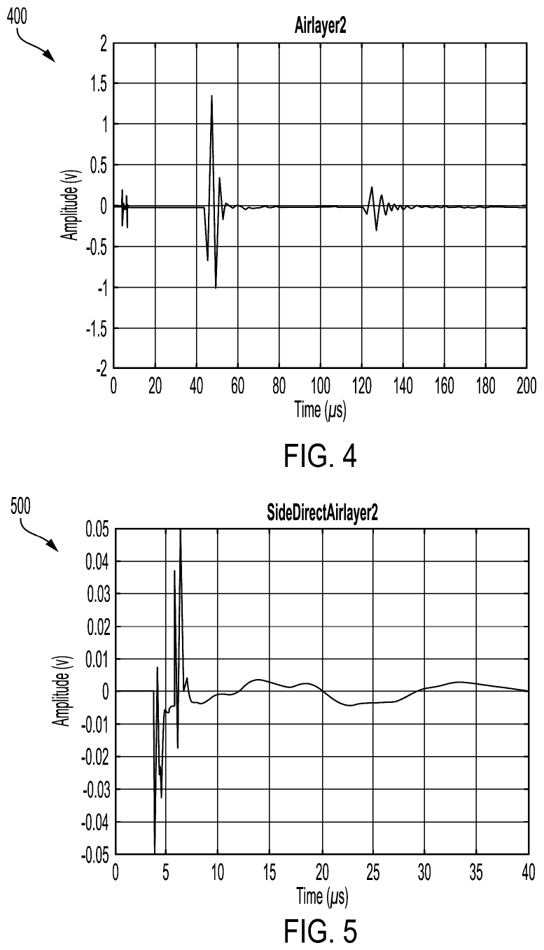

The ability of an air-gapped ultrasonic transducer according to examples of the present disclosure to prevent generated ultrasonic waves from leaving or reflected ultrasonic waves from being received by the air-gapped ultrasonic transducer through a side wall or a rear wall of the ultrasonic transducer housing is graphically illustrated in FIGS. 4-5.

The graph 400 of FIG. 4 is associated with the operation of an air-gapped ultrasonic transducer according to an example of the present disclosure that includes both transmitter and receiver functionality (i.e., is a transceiver). As may be observed from the graph, an ultrasonic wave is transmitted by the air-gapped ultrasonic transducer within the period of about 40 microseconds to about 50 microseconds. Likewise, a reflection of the ultrasonic wave is detected by the air-gapped ultrasonic transducer within the period of about 120 microseconds to about 140 microseconds. In between the periods of ultrasonic wave transmission and detection of the reflected ultrasonic wave, it may be observed that the signal generated by the air-gapped ultrasonic transducer is substantially smooth—i.e., is substantially free of noise as a result of the blocking of undesirable ultrasonic waves by the air gap of the air-gapped ultrasonic transducer. This results in a desired high SNR, indicating the applicability of an air-gapped ultrasonic transducer to tasks such as, for example, imaging and other wellbore operations where good signal clarity is needed.

The graph 500 of FIG. 5 is associated with the operation of the air-gapped ultrasonic transducer 200 of FIG. 2. The graph 500 of FIG. 5 is associated with a test case where an ultrasonic wave of approximately a 2 microsecond duration is directed at the side wall of the air-gapped ultrasonic transducer 200. The graph 500 illustrates how the air gap 208 of the air-gapped ultrasonic transducer 200 can minimize or eliminate noise by blocking reflected ultrasonic waves from reaching the piezoelectric element 210 of the air-gapped ultrasonic transducer 200 through the side or rear of the housing 202.

In FIG. 5, the signal generated by the air-gapped ultrasonic transducer 200 within the period from about 4 microseconds to about 8 microseconds is caused by magnetic electrical noise, which can again be ignored. The signal generated by the air-gapped ultrasonic transducer 200 within the period from about 8 microseconds to 40 microseconds represents detection of a reflection of the ultrasonic wave. As can be observed, the amplitude of the signal generated by the air-gapped ultrasonic transducer 200 exhibits minimal variance. This reveals that the ultrasonic wave blocking effect of the air gap 208 minimizes or eliminates the noise that would normally otherwise be present in the signal output by the air-gapped ultrasonic transducer 200 in response to the reflected ultrasonic test wave.

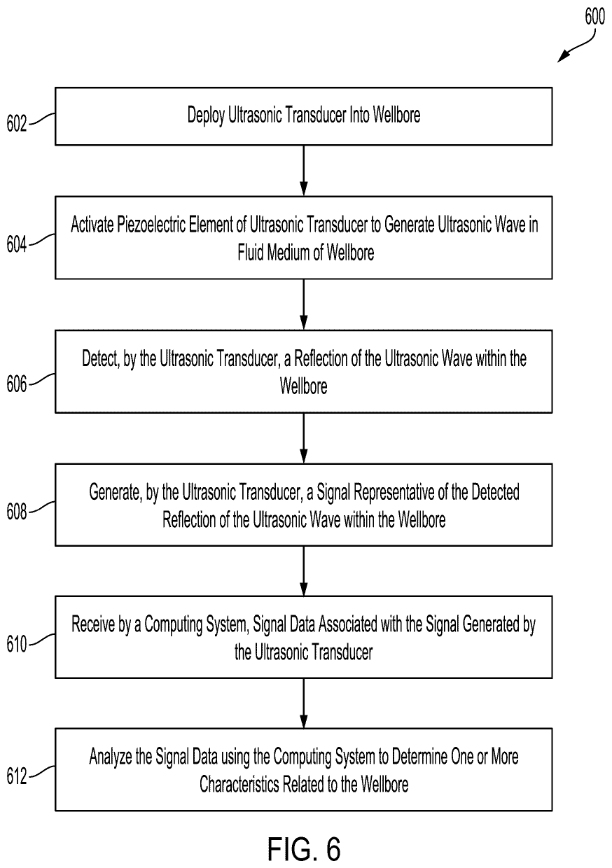

FIG. 6 is a flow chart 600 representing one example of a method for determining one or more characteristics related to a wellbore. As may be observed, at block 602 an ultrasonic transducer according to the present disclosure can be deployed into the wellbore. The ultrasonic transducer may be a component of a downhole tool designed to perform one or more wellbore inspections, imaging, etc., operations. The ultrasonic transducer can include a housing comprising an inner housing and an outer housing separated by an air gap that blocks ultrasonic wave transmission. The air gap can contain a gas or a fluid, or the air gap may be evacuated. The ultrasonic transducer can also include a piezoelectric element mounted in a space within the inner housing, and a cover that closes a front opening of the housing.

At block 604, the piezoelectric element of the ultrasonic transducer can be activated to generate an ultrasonic wave within a fluid medium in the wellbore. The fluid medium may be gas, or a liquid such as a fluidic hydrocarbon material, water, or mud, or some combination of a gas and a liquid.

At block 606, the ultrasonic transducer can detect a reflection of the ultrasonic wave within the wellbore. Detection of the reflected ultrasonic wave by the ultrasonic transducer may be performed by the piezoelectric element or by a separate ultrasonic receiver located in the housing of the ultrasonic transducer. The reflection of the ultrasonic wave may be caused by various aspects of the wellbore, including for example, a casing string, cement, or other features of the wellbore, or by an object located in the wellbore.

At block 608, the ultrasonic transducer can generate a signal that is representative of the detected reflection of the ultrasonic wave within the wellbore. The signal may convey various characteristics about the detected reflection.

At block 610, signal data associated with the signal generated by the ultrasonic transducer can be received by a processor of a computing system. The computing system may be located remotely from the wellbore, may be located at the surface of the formation in which the wellbore is located, etc. The signal data may be transmitted directly or indirectly to the computing system by the ultrasonic transducer, or can be otherwise provided thereto.

At block 612, the processor of the computing system may analyze the signal data to determine one or more characteristics related to the wellbore. The one or more characteristics may include, for example, a type of an object in the wellbore, a composition of an object in the wellbore, a location of an object in the wellbore, an impedance of a material in the wellbore, a deformity in a wall of the wellbore, which may be a fracture, a diameter of the wellbore, a shape of the wellbore, and various combinations thereof. In some examples, the signal data may be analyzed using artificial intelligence, such as by a machine learning model.

According to aspects of the present disclosure, an ultrasonic transducer, a sensor system, and a method, are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is an ultrasonic transducer for use in a wellbore comprising: a housing comprising an inner housing and an outer housing each having at least one side wall, and a rear wall, and an air gap separating the at least one side wall and the rear wall of the inner housing from the at least one side wall and the rear wall of the outer housing and functional to block ultrasonic waves; a piezoelectric element mounted in a space within the inner housing; and a cover closing an opening at a front of the housing through which ultrasonic waves are transmittable and receivable.

Example 2 is the ultrasonic transducer of example 1, wherein the piezoelectric element is operable as an ultrasonic transmitter, an ultrasonic receiver, or an ultrasonic transceiver having both transmitting and receiving functionality.

Example 3 is the ultrasonic transducer of example 1, wherein the piezoelectric element is operable as a transmitter and one or more ultrasonic receivers are located in the space within the inner housing along with the piezoelectric element to detect reflected ultrasonic waves within the wellbore.

Example 4 is the ultrasonic transducer of example 1, wherein the air gap contains a gas or a liquid, or is a vacuum, to help block ultrasonic waves generated by the piezoelectric element from being transmitted through a side or a rear of the housing and to help block reflected ultrasonic waves from being received by the piezoelectric element through the side or the rear of the housing.

Example 5 is the ultrasonic transducer of example 1, further comprising a plurality of air gap support elements located within the air gap at spaced intervals, each air gap support element of the plurality of air gap support elements extending between an outer wall of the inner housing and an inner wall of the outer housing to resist deformation of the air gap by external pressure forces.

Example 6 is the ultrasonic transducer of example 5, wherein the inner housing, the outer housing, or both the inner housing and the outer housing, are made of a non-metallic material comprising a plastic material or a composite material.

Example 7 is the ultrasonic transducer of example 1, further comprising a backing material located in the space within the inner housing, the backing material configured and positionable to assist the air gap to block ultrasonic waves by attenuating ultrasonic waves directed out of or into a rear of the housing, and having an acoustic impedance that matches an acoustic impedance of a crystal material from which the piezoelectric element is made.

Example 8 is a sensor system for use in a wellbore comprising: an ultrasonic transducer comprising a housing including an inner housing and an outer housing each having at least one side wall and a rear wall, an air gap separating the at least one side wall and the rear wall of the inner housing from the at least one side wall and the rear wall of the outer housing and functional to block ultrasonic waves, a piezoelectric element mounted in a space within the inner housing, the piezoelectric element operable to generate an ultrasonic wave within a fluid medium in the wellbore, and a cover closing an opening at a front of the housing through which ultrasonic waves are transmittable and receivable; a processor; and a memory communicatively coupled to the processor, the memory including instructions that are executable by the processor to cause the processor to perform operations comprising: receiving, from the ultrasonic transducer, signal data associated with a signal generated by the ultrasonic transducer in response to detection by the ultrasonic transducer of a reflected ultrasonic wave within the wellbore; and analyzing the signal data to determine one or more characteristics related to the wellbore.

Example 9 is the sensor system of example 8, wherein the ultrasonic transducer is configured to detect reflected ultrasonic waves using the piezoelectric element or using one or more ultrasonic receivers that are located in the space within the inner housing along with the piezoelectric element.

Example 10 is the sensor system of example 8, wherein the air gap contains a gas or a liquid, or is a vacuum, to help block ultrasonic waves generated by the piezoelectric element from being transmitted through a side or a rear of the housing and to help block reflected ultrasonic waves from being received by the piezoelectric element through the side or the rear of the housing.

Example 11 is the sensor system of example 8, wherein a plurality of air gap support elements are located within the air gap at spaced intervals, each air gap support element of the plurality of air gap support elements extending between an outer wall of the inner housing and an inner wall of the outer housing to resist deformation of the air gap by external pressure forces.

Example 12 is the sensor system of example 11, wherein the inner housing, the outer housing, or both the inner housing and the outer housing, are made of a non-metallic material comprising a plastic material or a composite material.

Example 13 is the sensor system of example 8, wherein the ultrasonic transducer further includes a backing material located in the space within the inner housing, the backing material configured and positionable to assist the air gap to block ultrasonic waves by attenuating ultrasonic waves directed out of or into a rear of the housing, and having an acoustic impedance that matches an acoustic impedance of a crystal material from which the piezoelectric element is made.

Example 14 is the sensor system of example 8, wherein the one or more characteristics related to the wellbore are selected from the group consisting of a type of an object in the wellbore, a composition of an object in the wellbore, a location of an object in the wellbore, an impedance of a material in the wellbore, a deformity in a wall of the wellbore, a diameter of the wellbore, a shape of the wellbore, and various combinations thereof.

Example 15 is the sensor system of example 8, wherein the ultrasonic transducer is a part of a cement evaluation tool that is deployable into the wellbore by a wireline, a slickline, or by tubing to evaluate a cement-to-pipe bond, to evaluate a cement-to-formation bond, to evaluate a cement-to-casing bond, to determine a presence of cement between two casing strings, or some combination thereof.

Example 16 is a method, comprising: deploying an ultrasonic transducer into a wellbore, the ultrasonic transducer comprising a housing including an inner housing and an outer housing each having at least one side wall and a rear wall, an air gap separating the at least one side wall and the rear wall of the inner housing from the at least one side wall and the rear wall of the outer housing and functional to block ultrasonic waves, a piezoelectric element mounted in a space within the inner housing, and a cover closing an opening at a front of the housing through which ultrasonic waves are transmittable and receivable; activating the piezoelectric element of the ultrasonic transducer to generate an ultrasonic wave within a fluid medium in the wellbore; detecting, by the ultrasonic transducer, a reflection of the ultrasonic wave within the wellbore; generating, by the ultrasonic transducer, a signal representative of the detected reflection of the ultrasonic wave within the wellbore; receiving, by a processor of a computing system, signal data associated with the signal generated by the ultrasonic transducer; and determining one or more characteristics related to the wellbore by analyzing the signal data using the processor of the computing system.

Example 17 is the method of example 16, wherein the air gap in the housing of the ultrasonic transducer contains a gas or a liquid, or is a vacuum, which helps block ultrasonic waves generated by the piezoelectric element from being transmitted through a side or a rear of the housing and to help block reflected ultrasonic waves from being received by the piezoelectric element through the side or the rear of the housing.

Example 18 is the method of example 16, wherein the one or more characteristics related to the wellbore are selected from the group consisting of a type of an object in the wellbore, a composition of an object in the wellbore, a location of an object in the wellbore, an impedance of a material in the wellbore, a deformity in a wall of the wellbore, a diameter of the wellbore, a shape of the wellbore, and various combinations thereof.

Example 19 is the method of example 16, wherein a signal-to-noise ratio of the signal generated by the ultrasonic transducer is between 20 decibels and 30 decibels.

Example 20 is the method of example 16, wherein the ultrasonic transducer is a part of a cement evaluation tool that is deployed into the wellbore by a wireline, a slickline, or by tubing to evaluate cement-to-pipe bond, to evaluate a cement-to-formation bond, to evaluate a cement-to-casing bond, to determine a presence of cement between two casing strings, or some combination thereof.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. An ultrasonic transducer for use in a wellbore comprising:
a housing comprising:
an inner housing and an outer housing each having at least one side wall, and a rear wall; and
an air gap separating the at least one side wall and the rear wall of the inner housing from the at least one side wall and the rear wall of the outer housing and functional to block ultrasonic waves;
a piezoelectric element mounted in a space within the inner housing; and
a cover closing an opening at a front of the housing through which ultrasonic waves are transmittable and receivable.

2. The ultrasonic transducer of claim 1, wherein the piezoelectric element is operable as an ultrasonic transmitter, an ultrasonic receiver, or an ultrasonic transceiver having both transmitting and receiving functionality.

3. The ultrasonic transducer of claim 1, wherein the piezoelectric element is operable as a transmitter and one or more ultrasonic receivers are located in the space within the inner housing along with the piezoelectric element to detect reflected ultrasonic waves within the wellbore.

4. The ultrasonic transducer of claim 1, wherein the air gap contains a gas or a liquid, or is a vacuum, to help block ultrasonic waves generated by the piezoelectric element from being transmitted through a side or a rear of the housing and to help block reflected ultrasonic waves from being received by the piezoelectric element through the side or the rear of the housing.

5. The ultrasonic transducer of claim 1, further comprising a plurality of air gap support elements located within the air gap at spaced intervals, each air gap support element of the plurality of air gap support elements extending between an outer wall of the inner housing and an inner wall of the outer housing to resist deformation of the air gap by external pressure forces.

6. The ultrasonic transducer of claim 5, wherein the inner housing, the outer housing, or both the inner housing and the outer housing, are made of a non-metallic material comprising a plastic material or a composite material.

7. The ultrasonic transducer of claim 1, further comprising a backing material located in the space within the inner housing, the backing material configured and positionable to assist the air gap to block ultrasonic waves by attenuating ultrasonic waves directed out of or into a rear of the housing, and having an acoustic impedance that matches an acoustic impedance of a crystal material from which the piezoelectric element is made.

8. A sensor system for use in a wellbore comprising:
an ultrasonic transducer comprising:
a housing including an inner housing and an outer housing each having at least one side wall, and a rear wall;
an air gap separating the at least one side wall and the rear wall of the inner housing from the at least one side wall and the rear wall of the outer housing and functional to block ultrasonic waves;
a piezoelectric element mounted in a space within the inner housing, the piezoelectric element operable to generate an ultrasonic wave within a fluid medium in the wellbore; and
a cover closing an opening at a front of the housing through which ultrasonic waves are transmittable and receivable;
a processor; and
a memory communicatively coupled to the processor, the memory including instructions that are executable by the processor to cause the processor to perform operations comprising:
receiving, from the ultrasonic transducer, signal data associated with a signal generated by the ultrasonic transducer in response to detection by the ultrasonic transducer of a reflected ultrasonic wave within the wellbore; and
analyzing the signal data to determine one or more characteristics related to the wellbore.

9. The sensor system of claim 8, wherein the ultrasonic transducer is configured to detect reflected ultrasonic waves using the piezoelectric element or using one or more ultrasonic receivers that are located in the space within the inner housing along with the piezoelectric element.

10. The sensor system of claim 8, wherein the air gap contains a gas or a liquid, or is a vacuum, to help block ultrasonic waves generated by the piezoelectric element from being transmitted through a side or a rear of the housing and to help block reflected ultrasonic waves from being received by the piezoelectric element through the side or the rear of the housing.

11. The sensor system of claim 8, wherein a plurality of air gap support elements are located within the air gap at spaced intervals, each air gap support element of the plurality of air gap support elements extending between an outer wall of the inner housing and an inner wall of the outer housing to resist deformation of the air gap by external pressure forces.

12. The sensor system of claim 11, wherein the inner housing, the outer housing, or both the inner housing and the outer housing, are made of a non-metallic material comprising a plastic material or a composite material.

13. The sensor system of claim 8, wherein the ultrasonic transducer further includes a backing material located in the space within the inner housing, the backing material configured and positionable to assist the air gap to block ultrasonic waves by attenuating ultrasonic waves directed out of or into a rear of the housing, and having an acoustic impedance that matches an acoustic impedance of a crystal material from which the piezoelectric element is made.

14. The sensor system of claim 8, wherein the one or more characteristics related to the wellbore are selected from the group consisting of a type of an object in the wellbore, a composition of an object in the wellbore, a location of an object in the wellbore, an impedance of a material in the wellbore, a deformity in a wall of the wellbore, a diameter of the wellbore, a shape of the wellbore, and various combinations thereof.

15. The sensor system of claim 8, wherein the ultrasonic transducer is a part of a cement evaluation tool that is deployable into the wellbore by a wireline, a slickline, or by tubing to evaluate a cement-to-pipe bond, to evaluate a cement-to-formation bond, to evaluate a cement-to-casing bond, to determine a presence of cement between two casing strings, or some combination thereof.

16. A method, comprising:
deploying an ultrasonic transducer into a wellbore, the ultrasonic transducer comprising:
a housing including an inner housing and an outer housing each having at least one side wall, and a rear wall;
an air gap separating the at least one side wall and the rear wall of the inner housing from the at least one side wall and the rear wall of the outer housing and functional to block ultrasonic waves;
a piezoelectric element mounted in a space within the inner housing; and
a cover closing an opening at a front of the housing through which ultrasonic waves are transmittable and receivable;
activating the piezoelectric element of the ultrasonic transducer to generate an ultrasonic wave within a fluid medium in the wellbore;
detecting, by the ultrasonic transducer, a reflection of the ultrasonic wave within the wellbore;
generating, by the ultrasonic transducer, a signal representative of the detected reflection of the ultrasonic wave within the wellbore;
receiving, by a processor of a computing system, signal data associated with the signal generated by the ultrasonic transducer; and
determining one or more characteristics related to the wellbore by analyzing the signal data using the processor of the computing system.

17. The method of claim 16, wherein the air gap in the housing of the ultrasonic transducer contains a gas or a liquid, or is a vacuum, which helps block ultrasonic waves generated by the piezoelectric element from being transmitted through a side or a rear of the housing and to help block reflected ultrasonic waves from being received by the piezoelectric element through the side or the rear of the housing.

18. The method of claim 16, wherein the one or more characteristics related to the wellbore are selected from the group consisting of a type of an object in the wellbore, a composition of an object in the wellbore, a location of an object in the wellbore, an impedance of a material in the wellbore, a deformity in a wall of the wellbore, a diameter of the wellbore, a shape of the wellbore, and various combinations thereof.

19. The method of claim 16, wherein a signal-to-noise ratio of the signal generated by the ultrasonic transducer is between 20 decibels and 30 decibels.

20. The method of claim 16, wherein the ultrasonic transducer is a part of a cement evaluation tool that is deployed into the wellbore by a wireline, a slickline, or by tubing to evaluate a cement-to-pipe bond, to evaluate a cement-to-formation bond, to evaluate a cement-to-casing bond, to determine a presence of cement between two casing strings, or some combination thereof.
